(19) United States
(12) Patent Application Publication
(10) Pub. No.: US 2026/0070083 A1
(43) Pub. Date: Mar. 12, 2026

(54) METHOD FOR MANUFACTURING TRANSLUCENT COMPONENTS OF AN OUTER SKIN OF A VEHICLE

(71) Applicant: Magna Exteriors (Bohemia) s.r.o., Liberec (CZ)

(72) Inventors: Radovan CÁP, Liberec (CZ); Ondrej VOHLÍDAL, Liberec (CZ)

(21) Appl. No.: 19/312,405

(22) Filed: Aug. 28, 2025

(30) Foreign Application Priority Data
Sep. 9, 2024 (DE) 102024125757.1

(51) Int. Cl. B05D 3/06

(52) U.S. Cl. CPC B05D 3/06

(57) ABSTRACT

The invention relates to a process for producing components of an outer skin of a vehicle, wherein the component comprises at least one transilluminable region. The process comprises the steps of: a) providing a main body produced from a light-permeable or transparent polymer material in an injection molding process, wherein the main body has a front side and a reverse side; b) applying a color-imparting coating to the front side of the main body, wherein this comprises a color-imparting, light-impermeable paint layer; c) treating the color-imparting coating in a two-stage laser process to produce the at least one transilluminable region, wherein in the first stage the color-imparting coating is removed using an IR laser and in the second stage the transilluminable region processed in the first stage is cleaned and smoothed using a UV laser; and d) applying a sealing clearcoat layer to the color-imparting coating and to the transilluminable region of the main body.

### CROSS-REFERENCE TO RELATED APPLICATIONS

This application claims priority to German Application No. DE 102024125757.1 filed on Sep. 9, 2024. The entire disclosure of the above application is incorporated herein by reference.

### FIELD OF THE INVENTION

The invention relates to a method for manufacturing translucent components of an outer skin of a vehicle, wherein the component in the form of an exterior trim piece is especially a front panel.

### BACKGROUND OF THE INVENTION

This section provides information related to the present disclosure which is not necessarily prior art.

Owing to the increasing usage of electric vehicles, requirements with regard to front panels are changing, since radiator inlet openings are not required to the same extent as for conventional motor vehicles having internal combustion engines.

Front modules in electric vehicles are receiving radiator trims that are ever more closed as a consequence of better aerodynamics of the vehicle coupled with reduced cooling air requirements.

Front panels can be manufactured from transparent polycarbonate and provided with suitable decorative elements or else functional elements, for example lighting modules. To this end the front panels are produced in a two-component injection molding process according to the prior art. The reverse side, i.e. the vehicle inner surface of the three dimensionally formed front panel, is subsequently painted and the front side, i.e. the outer surface of the vehicle, must be protected from overspray. To this end, the front side is masked. To produce multicolored structures, embossed geometries of the front panel are exposed using a laser. This is followed by coating of the inner surface by a physical vapor deposition process (PVD) to obtain a chrome effect with simultaneously light transparency. The front side receives a hardcoat coating.

DE 10 2018 124 384 A1 discloses a light-permeable trim piece for a motor vehicle which comprises a main body made of a translucent or transparent polymer material. A color-imparting coating is applied to the main body, wherein the color-imparting coating is preferably formed by a paint layer or a paint film. To illuminate the trim piece, certain regions of the color-imparting coating exhibit a multiplicity of point-like perforations introduced using a laser. A clearcoat layer is applied atop the color-imparting coating as a protective layer.

### SUMMARY OF THE INVENTION

This section provides a general summary of the disclosure, and is not a comprehensive disclosure of its full scope or all of its features.

It is an object of the invention to provide a process for producing transilluminable components of an outer skin of a vehicle.

The process according to the invention shall especially be performable using standard techniques such as injection molding, painting and laser ablation.

The object is achieved by a process for producing transilluminable components of an outer skin of a vehicle.

The process for producing components of an outer skin of a vehicle, wherein the component comprises at least one transilluminable region, comprises the steps of:
a) providing a main body produced from a light-permeable or transparent polymer material in an injection molding process, wherein the main body has a front side and a reverse side;
b) applying a color-imparting coating to the front surface of the main body, wherein this comprises a color-imparting, light-impermeable paint layer;
c) treating the color-imparting coating in a two-stage laser process to produce the at least one transilluminable region, wherein in the first stage the color-imparting coating is removed using an IR laser and in the second stage the transilluminable region processed in the first stage is cleaned and smoothed using a UV laser; and
d) applying a sealing clearcoat layer to the color-imparting coating and to the transilluminable region of the main body.

The process according to the invention is carried out in a plurality of steps and comprises a two-stage laser treatment by ablation of the color-imparting coating of the main body in the at least one transilluminable region.

To achieve a maximum light permeability in the transilluminable region the color-imparting coating, preferably a paint layer, is ablated using an infrared laser in the first stage of the laser treatment.

In a subsequent second stage of the laser treatment the roughness of the laser-ablated region is then smoothed by means of a further laser ablation to maximize the light permeability of the light-permeable material on the main body of the component.

The process according to the invention accordingly comprises two stages of a laser ablation process, wherein the first step is performed using an infrared laser and the second step of the laser ablation process is carried out using a UV laser.

The component produced by the process according to the invention may be provided with ambient or design lighting features in one or more regions.

The produced component of an outer skin may comprise one or more regions comprising a functional lighting feature, for example comprising a DRL.

The component produced by the process according to the invention is preferably employable as a front panel of a front module.

The lighting system according to the invention makes it possible to at least temporarily provide the user of a motor vehicle and/or a road user with different functional lighting features. The lighting features may include both safety-relevant aspects and communication options via illuminated symbols or scripts.

The lighting functions may also include design features. This makes it possible to broaden the possible functions for illuminated front panels. To this end the transilluminable region is configured with a perforation so as to result in a perforation pattern which is used for ambient lighting or for design purposes. Also conceivable as a further function that may be integrated is the indicator function for example. For ambient lighting the transilluminable region is preferably not visible to a user from the outer surface in the unilluminated state.

In a particularly preferred embodiment, the color-imparting coating of the light-impermeable region of the main body is the same color as the color-imparting coating of the body of the overall motor vehicle.

The outer surface or else visible surface is considered to be the surface region visible to a user from the external environment. The inner surface is accordingly the side opposite the outer surface facing inward.

A transilluminable component of an outer skin is especially to be understood as meaning an exterior trim piece such as for example a front panel, a bumper trim, a tailgate trim, a door trim, a roof trim or a spoiler or is a component of one of the aforementioned parts.

The component of an outer skin is three-dimensional.

The component is produced from a thermoplastic, preferably from a light-permeable translucent polypropylene, in an injection molding process. The translucent polypropylene material contains no further fillers such as talc or the like. This prevents a reduction in light permeability.

It is preferable when the reverse of the component is masked with a masking element in the transilluminable region in a step prior to the applying of the coating. The masking element is applied by adhesive bonding or directly on the product holder in the painting facility and fully masks the reverse side. The masking using a masking element, preferably a masking tape, avoids contamination of the transilluminable region by overspray upon production of the coating during the step of paint application.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a cross section of a construction of a component in the form of a front panel having a lighting function.

FIG. 2 shows in a schematic representation a section of a process according to the invention for producing a component of an outer skin.

FIG. 3 shows in an exploded view a front module of a vehicle having a front panel produced according to the invention.

FIG. 4 shows a section of a front panel having an ambient lighting feature and a functional lighting feature comprising a plurality of transilluminable regions as well as a detail view of the transilluminable regions.

### DESCRIPTION OF THE INVENTION

The process according to the invention for producing transilluminable components of an outer skin of a vehicle will now be described by way of example with reference to a front panel in the form of an exterior trim in the frontal region of an electric vehicle. It goes without saying that such a component of an outer skin of a vehicle in the form of an exterior trim piece may also be employed as a trim element in any other place on a motor vehicle. The component is preferably also a bumper trim, a tailgate trim, a door trim, a roof trim or a spoiler or is an element of one of the aforementioned parts.

A front panel 1 is shown in the drawings in a schematic sectional view and has an outer surface (A) and an inner surface (I). The outer surface is the visible side of the outer skin of the motor vehicle in the intended installation position on the motor vehicle and is visible to a user.

The front panel 1 essentially comprises a main body 10 made of a light-permeable or transparent polymer material. The main body 10 is produced from a polypropylene in an injection molding process and has a front side 10a facing outward and a reverse side 10b facing inward. The main body 10 is provided on the front side 10a with an opaque coating 30. The coating 30 is multi-layered and comprises an adhesion promoter layer 31 (primer) applied to the main body 10 and a color-imparting paint layer 32 applied thereto.

At least one region of the front panel 1 is in the form of a transilluminable region 11, wherein to realize a lighting function which may fulfill a functional lighting function or else an ambient lighting function for design purposes a lighting element 40 is arranged behind the transilluminable region 11 on the inner surface of the front panel 1.

To achieve transillumination of the light of the lighting element 40 from the inner surface through the transilluminable region 11 to the outer surface of the component 1, the coating 30 of the main body 10 is in the transilluminable region 11 provided with a perforation 14 produced by a two-stage laser treatment process.

The perforation 14 by means of the laser treatment process may be configured such that the coating 30 is completely ablated in the transilluminable region 11. In an alternative embodiment the perforation 14 may be configured such that it results in a perforation pattern used for ambient lighting or for design purposes. The two variants are more particularly described with reference to the drawings which follow.

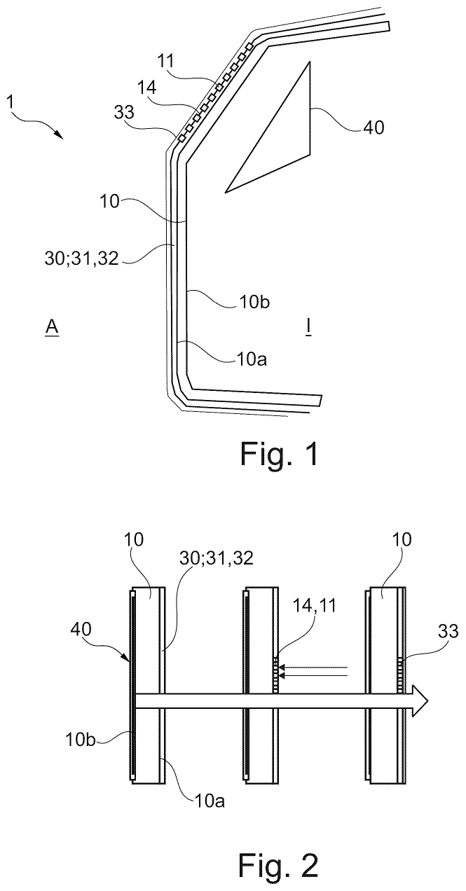

As is also apparent from FIG. 1, the main body 10 is on its front side 10a also provided with a clearcoat layer 33 which seals the color-imparting, light-impermeable paint layer 32. This is applied over the complete front side 10a including in the region of the transilluminable region 11.

The process according to the invention for producing the transilluminable component of an outer skin of a vehicle comprises the following steps:

In a first step, the main body 10 made of a light-permeable or transparent polymer material is produced from a thermoplastic, preferably a polypropylene, in an injection molding process and provided.

In a second step, the reverse side 10b of the main body 10 is masked with a masking element 50 in the region of the transilluminable region 11 or the reverse side is fully masked using a product holder of the painting facility. The masking element 50 is for example a masking tape applied by adhesive bonding.

In a subsequent third step, the color-imparting coating 30 is applied to the front side 10a of the main body 10. The coating 30 is multilayered and initially comprises applying an adhesion promoter layer (primer) 31 to the front side 10a.

This is followed by application of a color-imparting, light-impermeable paint layer 32 to the previously applied adhesion promoter layer 31. The application of the color-imparting coating 30 is shown in step A in FIG. 2.

Application of the color-imparting coating layer 32 is followed by the two-stage laser treatment of the color-imparting coating 30 to produce the at least one transilluminable region 11. The two-stage laser treatment is shown in step B in FIG. 2.

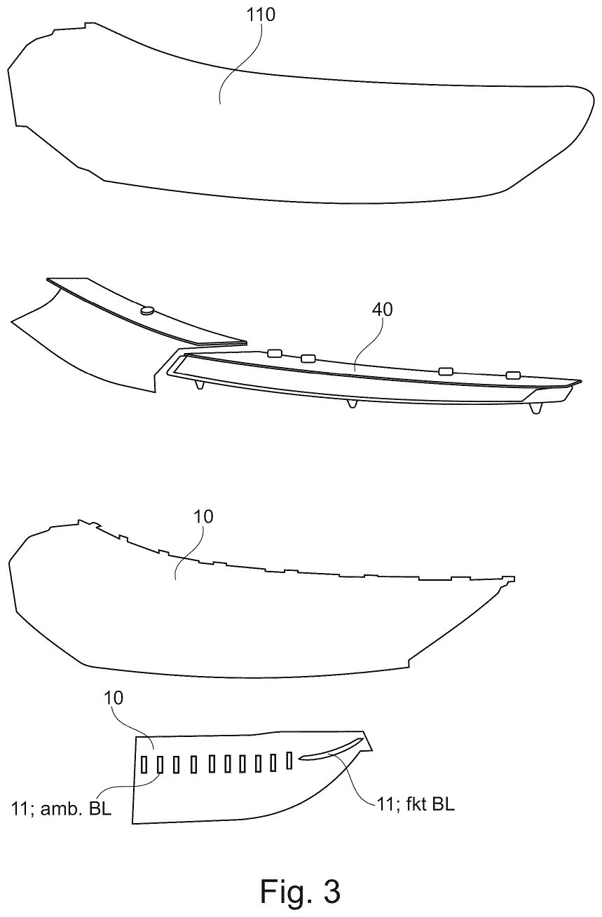

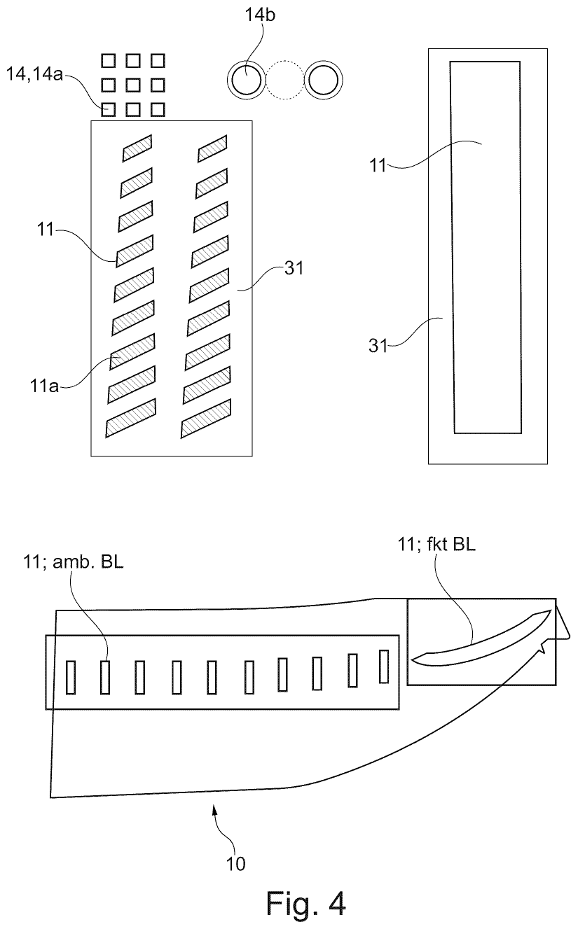

FIG. 3 shows on the right-hand side of the front panel a marked section which comprises four transilluminable regions 11 configured for a functional lighting feature (fkt. BL). As is apparent from the enlarged view of one of the transilluminable regions, the corresponding region is configured as a light window, wherein the color-imparting coating 30 is completely removed by means of the two-stage laser treatment.

### Description of Two-Stage Laser Treatment

To produce the transilluminable region 11 for use as functional lighting (fkt. BL), for example as a daytime running light (DRL) etc., the laser ablation in the transilluminable region 11 is complete.

1st stage: The removal of the coating 30, especially of the color-imparting coating layer 31, is carried out using an infrared laser having a power of 200 W. This rapidly removes the coating from the surface in the case of complete ablation. This laser treatment of the 1st stage is carried out in 2 tiers. The first run is carried out in a first direction and the second run then follows in a direction which is at 90° to the first direction. In the first direction the laser is passed linearly over the surface of the coating to be ablated. A line of the laser is actually a series of pulses in nanoseconds with an overlap of 90%. This results in an appearance of a clean line. The next laser line is performed with an overlap of about 30%. This ensures that the entire surface is lasered uniformly and the transilluminable region 11 is completely freed of the paint layer 31. However, the high energy of the IR laser and the speed at which the paint is ablated has the result that the surface of the treated section becomes rough. To ensure the best light permeability the roughness must be minimized.

2nd stage: A “cleaning” (polishing) of the rough surface ablated with the IR laser in the transilluminable region 11 is achieved using a UV laser, for example at 3 W/in. This step maximizes the light permeability of the main body made of a polymer material. Due to the wavelength which is distinct from stage 1 and the markedly lower energy and also heat, the surface of the transilluminable region 11 is smoothed. The roughness of the preceding laser ablation in stage 1 is minimized.

FIG. 3 shows on the left-hand side of the front panel 1 a marked section which comprises a transilluminable region 11 configured for an ambient lighting feature (amb. BL). As is apparent from the enlarged view of the transilluminable region 11 of the ambient lighting feature, the corresponding region is shown with a pattern of rectangular sections 11a. Each of the rectangular sections is produced by introduction of a perforation 14 by laser treatment. The corresponding perforation pattern 14a is likewise shown in the drawing and comprises a multiplicity of dots 14b introduced in cross section using a laser. The corresponding perforation pattern 14a of the rectangular sections is generated by dots introduced using a laser which have a diameter of 100 μm and a distance to one another of 100 μm.

The dots are configured and introduced such that the dots have a diameter of at least 0.1 mm and a spacing (center point to center point of adjacent dot) of at least 0.2 mm. The larger the diameter of the dots, the more dots are visible from the outer surface of the front panel 1 when they are not illuminated.

The minimum distance of 0.1 mm of the dots from the outer lateral surface of the adjacent dots to one another ensures that the dots, i.e. the perforation pattern, are not visible in the case of a dark color when the lighting element 40 is not switched on, i.e. no light is emitted from the inner surface to the outer surface.

A clearcoat layer 33 sealing the color-imparting coating 30 is subsequently applied. This is also applied in the transilluminable region 11 to protect the laser-cut regions and retain the same surface quality as the surrounding color-imparting coating 30. The sealing step is shown as step C in FIG. 2.

The masking element 50 on the reverse side of the main body 10 is subsequently removed (unmasking of the masking tape).

The front module 100 shown in the FIG. is shown in an exploded diagram and essentially comprises a housing element 110 facing inward which is designed for receiving the lighting element 40 in a corresponding receiving space. The lighting element 40 is configured as an LED light module in known fashion and shall not be more particularly described. The lighting element is outwardly covered with the front panel 1 which is securely held on the housing element via corresponding securing points. As is apparent from the exploded diagram in the bottom-right of the page, in the right hand outer section of the front panel 1 the front panel comprises both a section with an ambient lighting feature (amb. BL) and a section with a functional lighting feature (fkt. BL).

1. A process for producing a component of an outer skin of a vehicle, wherein the component comprises at least one transilluminable region, the process comprising the steps of:
a) providing a main body produced from a light-permeable or transparent polymer material in an injection molding process, wherein the main body has a front side and a reverse side;
b) applying a color-imparting coating to the front surface of the main body, wherein this coating comprises a color-imparting, light impermeable paint layer;
c) treating the color-imparting coating in a two-stage laser process to produce the at least one transilluminable region, wherein in the first stage the color-imparting coating is removed using an IR laser and in the second stage the transilluminable region processed in the first stage is cleaned and smoothed using a UV laser; and
d) applying a sealing clearcoat layer to the color-imparting coating and to the transilluminable region of the main body.

2. The process for producing the component of an outer skin of a vehicle as claimed in claim 1, wherein in step c) in the first stage for achieving an ambient lighting region a perforation in the form of a perforation pattern is introduced into the color coating using the IR laser, and wherein the perforation pattern comprises a multiplicity of dots which have a diameter of at least 100 μm and wherein adjacent dots have a distance to one another of at least 100 μm.

3. The process for producing the component of an outer skin of a vehicle as claimed in claim 1, wherein in step c) in the first stage for achieving a functional lighting region the color-imparting coating is completely ablated in a two-tiered laser process in the transilluminable region.

4. The process for producing the component of an outer skin of a vehicle as claimed in claim 3, wherein the two-tiered laser process is carried out in a first direction in a first run, wherein the laser achieves a linear ablation of the coating and the adjacent lines are introduced with an overlap of 30% and the second run of the laser ablation is then carried out in a direction which is at 90° to the first direction.

5. The process for producing the component of an outer skin of a vehicle as claimed in claim 1, further comprises masking the reverse side of the main body in the transilluminable region with a masking element after step a) and before step b), wherein the masking element is preferably applied by adhesive bonding, and unmasking the masking element on the reverse side of the main body after step d).

6. The process for producing the component of an outer skin of a vehicle as claimed in claim 1, wherein the color-imparting coating is multilayered and the process comprises initially applying an adhesion promoter layer to the front side of the main body and subsequently applying the color-imparting, light-impermeable paint layer.

7. The process for producing the component of an outer skin of a vehicle as claimed in claim 1, wherein the component is a front panel and comprises both transilluminable regions for use as an ambient lighting function and transilluminable regions for use as a functional lighting function.
